(19) United States
(12) Patent Application Publication
(10) Pub. No.: US 2014/0110591 A1
(43) Pub. Date: Apr. 24, 2014

(54) DEVICE FOR CHARACTERIZING AN IONIZING RADIATION

(71) Applicant: COMMISSARIAT Á L'ÉNERGIE ATOMIQUE ET AUX ÉNERGIES ALTERNATIVES, Paris (FR)

(72) Inventors: Vincent REBOUD, Paris (FR); Stefan Landis, Voiron (FR)

(73) Assignee: COMMISSARIAT A L'ENERGIE ATOMIQUE ET AUX ENERGIES ALTERNATIVES, Paris (FR)

(21) Appl. No.: 14/058,930

(22) Filed: Oct. 21, 2013

(30) Foreign Application Priority Data
Oct. 22, 2012 (FR) 12 60024

(51) Int. Cl. G01T 1/20

(52) U.S. Cl. CPC G01T 1/2002; G01T 1/2006
USPC 250/366; 250/487.1; 250/473.1; 427/162

(57) ABSTRACT

The invention proposes a device (10) for characterizing an ionizing radiation used in an ambient medium having a first refraction index (n₁), the device (10) comprising:
a scintillator material (12) delimited by a wall (28), the scintillator material (12) generating photons under the effect of an ionizing radiation, the scintillator material (12) having a second refraction index (n₂), and
a guide layer (16) in contact with at least part of the wall (28), the guide layer (16) guiding, toward a predetermined zone, the photons generated by the scintillator material (12) and having an angle of incidence relative to the part of the wall (28) greater than or equal to the arcsin of the ratio of the first refraction index (n₁) to the second refraction index (n₂).

The present invention relates to a device for characterizing an ionizing radiation. The invention also relates to a method for manufacturing the device and the use of the device for characterizing an ionizing radiation.

An ionizing radiation, in the context of the invention, it is a high-energy particle radiation (gamma radiation, ionizing rays or simply events). The ionizing radiation is for example an X or gamma radiation, electron beam, a charged particle beam or a neutral particle beam.

The characterization of such a radiation is applicable in different fields, such as radiology, physics, physiology, chemistry, or mining and oil exploration. As an example, positron emission tomography (also called PET) and cosmic radiation characterization are also applications.

To that end, it is known to use a scintillator material. This material is an organic or crystalline material, which emits photons (sometimes called scintillation photons) under the effect of an ionizing radiation.

The interaction between the scintillator material and the ionizing radiation leads to an ionizing event. This event leads to the formation of photons through a photoelectric effect or a Compton inelastic scattering. Depending on the case, the photoelectric effect or the Compton inelastic scattering predominates.

The photons generated by the scintillator material are characterized by the position of their creation site and their energy. Determining the position of the creation site means knowing the position of the interaction between the ionizing radiation and the scintillator material. This knowledge makes it possible to determine the direction of the radiation, and therefore to obtain an estimate of the location of the source of the ionizing radiation. The energy of the photons makes it possible to access the energy of the incident ionizing radiation.

Thus, for certain applications, only the position of the interaction is sought. This is obtained owing to a good spatial resolution of the measuring device. The position of the ionizing event is determined for example by computing the barycenter of the position of the visible photons detected by the measuring device.

To favor the determination of the interaction point, it is known to paint the scintillator material black, as indicated by the article by G. Llosá et. al entitled “Characterization of a pet detector head based on continuous lyso crystals and monolithic, 64-pixel silicon photomultiplier matrices”, and which was published in the review Phys. Med. Biol., 2010, volume 55 on pages 7299-7315. The photons having to undergo a reflection that causes them to lose positioning information are thus absorbed by the black layer. Thus, only the photons not having undergone reflection are detected and participate in the precise determination of the position of the event.

However, the number of photons collected by the device is low, which makes the determination of the energy by that device relatively imprecise.

In fact, in the event it is the energy that is measured, for statistical reasons, the higher the number of collected photons, the more precise the estimate of the energy will be.

To increase the number of collected photons, the article by G. Llosá et al. proposes painting the scintillator material white. The number of photons leaving the scintillator material is in fact increased in this configuration, but the determination of the position of the event is deteriorated, since the photons having undergone at least one reflection in the scintillator are detected.

It is also known to use photonic crystals to extract a larger quantity of photons. This idea is described in the article by Arno Knapitsch et al. entitled “Photonic crystals: A novel approach to enhance the light output of scintillation based detectors” and which was published in the journal Nuclear Instruments & Methods in Physics Research Section A-accelerators Spectrometers Detectors and Associated Equipment—NUCL INSTRUM METH PHYS RES A, vol. 628, no. 1, 2011 on pages 385 to 388. The use of photonic crystals in the context of scintillator materials is also described in the article by M. Kronberger et al. entitled “Improving Light Extraction From Heavy Inorganic Scintillators by Photonic Crystals” and which was published in the journal Nuclear Science, IEEE Transactions on Volume: 57, Issue: 5, Part: 1, 2012 on pages 2475 to 2482.

However, major variations exist in the angular emission diagram of the photons diffracted through the photonic crystals based on the wavelength of the photons generated by the scintillator material. This limits the precision that may be obtained in determining the position of the interaction, between the ionizing radiation and the scintillator material.

Document WO-A-2010/109344 proposes combining the use of photonic crystals with materials having an optical index lower than 1 to improve the capture and extraction efficiency of the photons generated by the scintillator material.

However, in the system of document WO-A-2010/109344, the collected photons undergo at least one total reflection or diffraction, which causes them to lose information on the interaction point. This portion of detected photons then generates an enlargement and deformation of the emission spot (this phenomenon generally being called photon spreading) on the photodetector, causing errors in the determination of the interaction position of the event in the scintillator material.

Thus, the devices previously described only precisely provide access to one of the two pieces of information (position of the interaction or energy).

There is therefore a need for a device for characterizing an ionizing radiation making it possible to obtain a precise characterization both in terms of energy and position.

To that end, a device is proposed for characterizing an ionizing radiation used in an ambient medium having a first refraction index. The device comprises a scintillator material delimited by a wall, the scintillator material generating photons under the effect of an ionizing radiation, the scintillator material having a second refraction index. The device includes a guide layer in contact with at least part of the wall, the guide layer guiding, toward a predetermined zone, the photons generated by the scintillator material and having an angle of incidence relative to the part of the wall greater than or equal to the arcsin of the ratio of the first refraction index to the second refraction index.

According to specific embodiments, the method comprises one or more of the following features, considered alone or according to all technically possible combinations:
the material of the guide layer has a third refraction index, the third refraction index being greater than the first and second refraction indices;
the guide layer includes at least one diffracting element suitable for orienting photons in a predetermined direction;
at least one of the diffracting element(s) is arranged to inject photons generated by the scintillator material toward the guide layer;
at least one of the diffracting element(s) is arranged to extract the photons guided by the guide layer outside the guide layer;
the device comprises a central zone and a peripheral zone, the predetermined zone being the peripheral zone and the diffractive elements being situated in the peripheral zone;
the device comprises a detector including several photodetectors, some of the photodetectors being situated in the central zone and other photodetectors being situated in the peripheral zone;
the diffracting elements are chosen from a group made up of a photonic crystal and a surface having a roughness comprised between 10 nm and 2.0 μm;
the guide layer completely surrounds the wall; and
the scintillator material is a rectangular rhomb whereof the edges have a bevel.

Also proposed is a device for characterizing a radiation emitted by a substantially isotropic emission source used in an ambient medium. The ambient medium has a first refraction index. The device comprises:
a substantially isotropic emission light source delimited by a wall, the source generating photons and the wall being made from a material having a second refraction index, and
a guide layer in contact with at least part of the wall, the guide layer guiding the photons generated by the source toward a predetermined zone and having an angle of incidence relative to the part of the wall greater than or equal to the arcsin of the ratio of the first refraction index to the second refraction index.

According to specific embodiments, the device for characterizing a radiation emitted by a lambertian emission source comprises one or more of the following features, considered alone or according to any technically possible combinations:
the light source is generated by the absorption of an ionizing radiation;
the light source is a scintillator capable of absorbing an ionizing radiation;
the material of the guide layer has a third refraction index, the third refraction index being greater than the first and second refraction indices;
the guide layer includes at least one diffracting element suitable for orienting the photons in a predetermined direction;
at least one of the diffracting element(s) is arranged to inject photons generated by the substantially isotropic emission light source toward the guide layer;
at least one of the diffracting element(s) is arranged to extract the photons guided from the guide layer outside the guide layer;
the device comprises a central zone and a peripheral zone, the predetermined zone being the peripheral zone and the diffracting elements being situated in the peripheral zone;
the device comprises a detector including several photodetectors, some of the photodetectors being situated in the central zone and other photodetectors being situated in the peripheral zone;
the diffractive elements are chosen from a group made up of a photonic crystal and a surface having a roughness comprised between 10 nm and 2.0 μm;
the guide layer completely surrounds the wall; and
the substantially isotropic emission light source is a rectangular rhomb whereof the edges have a bevel.

The invention also relates to a method for manufacturing a device as described above, comprising the steps of chemical vapor deposition of the guide layer on the wall of the scintillator material and lithography of the diffracting elements, in particular by nanoprinting on a film deposited on the guide layer.

The invention also relates to a use of a device as previously described to characterize an ionizing radiation.

According to specific embodiments, the use comprises one or more of the following features, considered alone or according to any technically possible combinations:
the characterization includes determining the energy of the ionizing radiation; and
the characterization includes determining the point of interaction between the ionizing radiation and the scintillator material.

Other features and advantages of the invention will appear upon reading the following detailed description of embodiments of the invention, provided solely as an example and in reference to the drawings, which are:

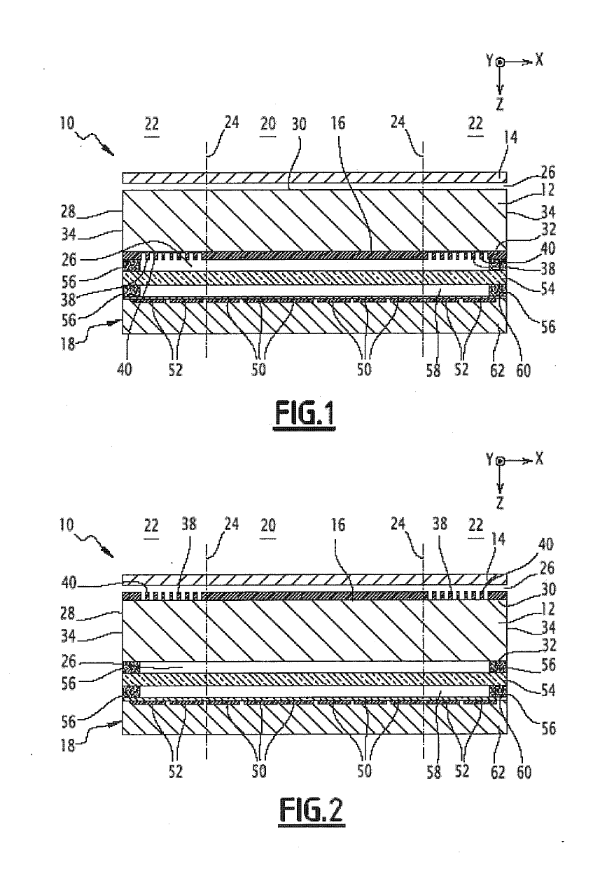

FIG. 1, a diagrammatic cross-sectional view of the device according to one embodiment of the invention;

FIG. 2, a diagrammatic cross-sectional view of the device according to another embodiment of the invention;

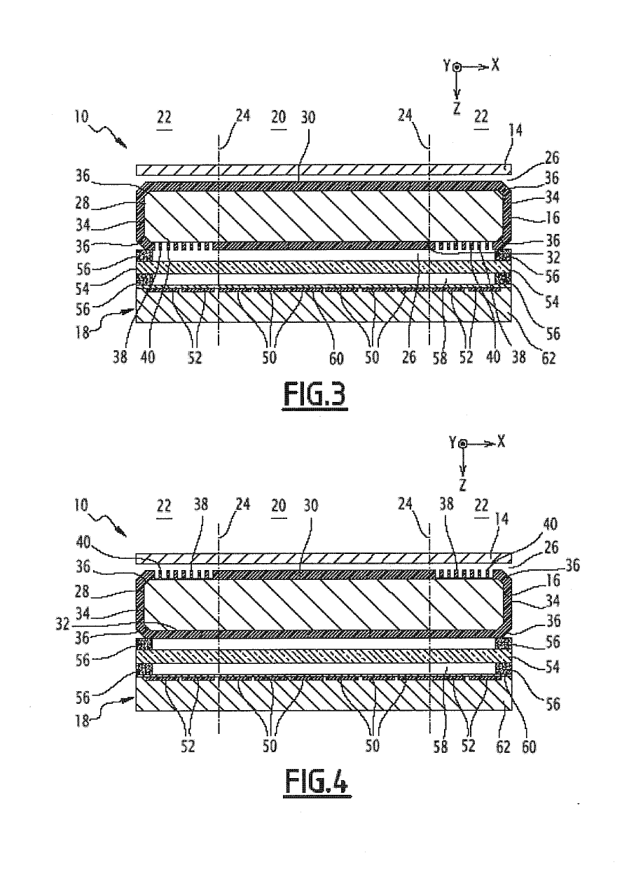

FIG. 3, a diagrammatic cross-sectional view of the device according to still another embodiment of the invention;

FIG. 4, a diagrammatic cross-sectional view of the device according to still another embodiment of the invention;

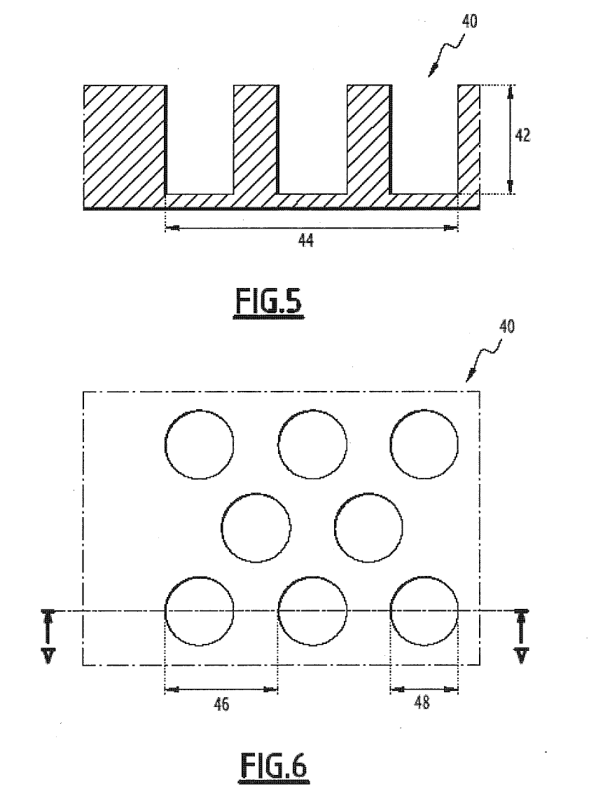

FIG. 5, a diagrammatic cross-sectional view along the axis V of FIG. 6 of a photonic crystal example;

FIG. 6, a diagrammatic elevation view of the photonic crystal example;

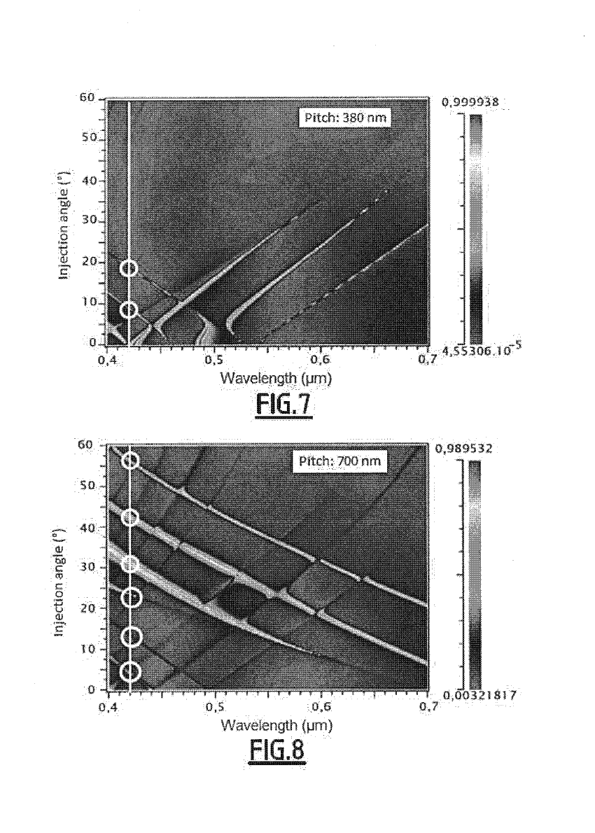

FIG. 7, a graph showing the simulated coupling of a light wave in the guide layer according to the invention based on the angle of incidence and the wavelength, the guide layer being provided with a photonic crystal according to a first geometry;

FIG. 8, a graph showing the simulated coupling of a light wave in the guide layer according to the invention based on the angle of incidence and the wavelength, the guide layer being provided with a photonic crystal according to a second geometry;

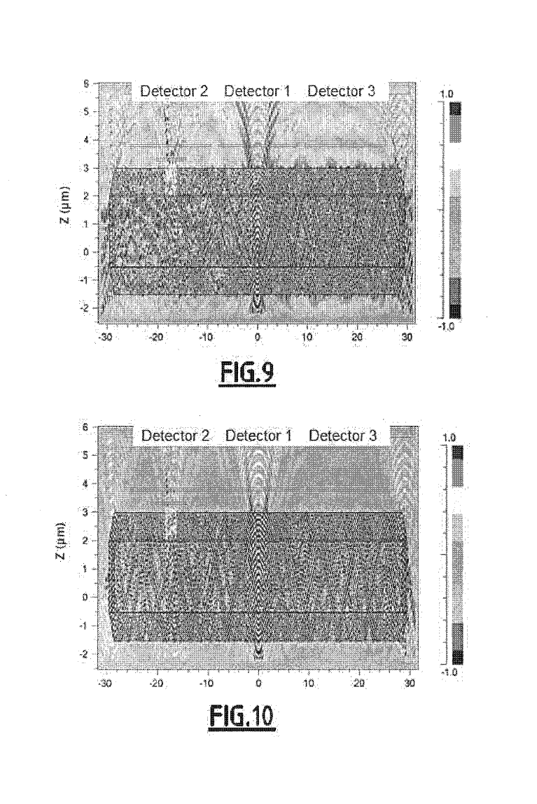

FIG. 9, a mapping of the electrical field produced by an ionizing radiation in a scintillator;

FIG. 10, a mapping of the magnetic field produced by an ionizing radiation in a scintillator;

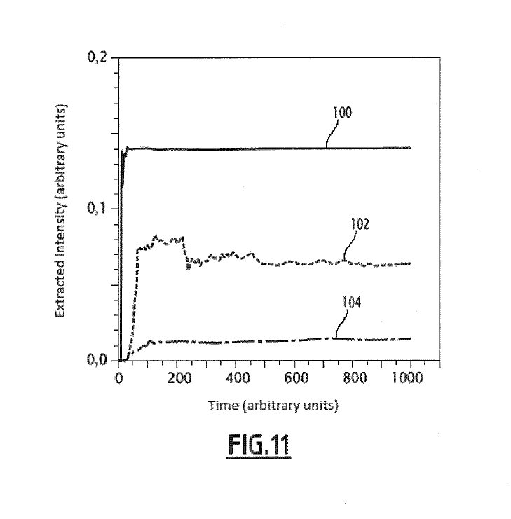

FIG. 11, a graph showing the evolution of the signal detected by several detectors in the example of FIGS. 9 and 10 as a function of time;

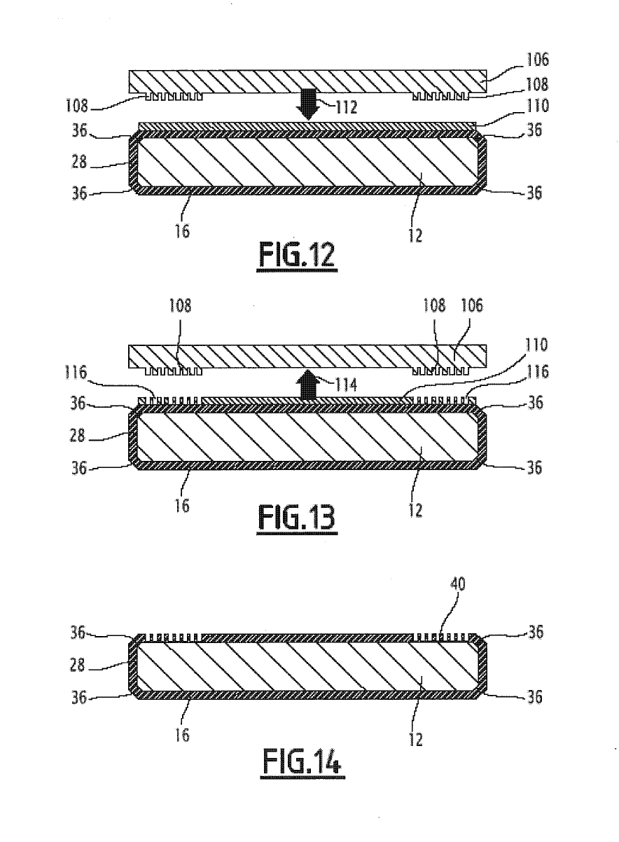

FIGS. 12 to 14, different steps of an example of manufacturing of photonic crystals on a guide layer of a scintillator material.

A device 10 for characterizing an ionizing radiation is shown in FIG. 1.

The characterization device 10 assumes the form of a multilayer component, each layer being arranged above another.

In this multilayered arrangement, the device 10 includes a scintillator material 12. Hereafter, it is considered that the ionizing radiation is absorbed by the scintillator material 12. This interaction generates from several hundred to several thousand photons.

The device 10 also comprises a retroreflector 14, a guide layer 16 and a detector 18. In the example of FIG. 1, the detector 18 makes it possible to define two transverse axes X and Y. The axis X is in the plane of the figure, while the axis Y is perpendicular to the plane of the figure. An axis Z is also defined perpendicular to the axes X and Y, the axis Z being oriented from the scintillator material 12 toward the detector 18.

Furthermore, the device 10 has a central zone 20 and a peripheral zone 22. The demarcation between the central zone 20 and the peripheral zone 22 is embodied in FIG. 1 by dotted lines 24.

The characterization device 10 is used in an ambient medium 26 having a first refraction index n₁. Typically, the ambient medium 26 is air. In this case, the first refraction index n₁ is approximately 1.0.

The scintillator material 12 is a monolithic material. In other words, the scintillator material 12 is of the bulk type. This terminology means that the material is solid.

Alternatively, the scintillator material 12 is a series of assembled monolithic scintillators.

In the case of FIG. 1, the device 10 comprises a scintillator material 12 delimited by a wall 28. The wall 28 is a wall outside the scintillator material 12.

According to the example of FIG. 1, the scintillator material 12 forms a rectangular rhomb.

Thus, for the scintillator material 12, a front face 30 and a rear face 32 are defined, the two faces being perpendicular to the axis Z and extending along a direction parallel to the axis X. Furthermore, the material also includes side faces 34 extending along a direction parallel to the axis Z.

The front face 30 forms a rectangle having a length (in a direction parallel to the axis X) and a width (in a direction parallel to the axis Y). The length is comprised between several hundred micrometers and several tens of cm, and is in particular equal to 5 cm. The width is comprised between several hundred micrometers and several tens of cm, and is in particular equal to 5 cm.

The thickness of the scintillator material 12, defined as the distance between the front and rear faces, is comprised between 5 mm and 4 cm, and is in particular equal to 1 cm.

In the examples of FIGS. 3 and 4, the edges of the scintillator material 12 have a bevel 36. This makes it possible to favor the guiding of the light in the guide layer 16.

The bevels 36 shown in FIGS. 3 and 4 extend in a direction parallel to the axis Y.

The scintillator material 12 generates photons when the ionizing radiation interacts therein.

The scintillator material 12 is capable of emitting between several hundred and several tens of thousands of photons per ionizing event. More specifically, the quantity of photons generated in the scintillator material 12 depends on the energy deposited by the ionizing radiation during the interaction, most often based on a proportionality relationship.

As an example, the scintillator material 12 is made from a cerium-doped silicate yttrium lutetium crystal. Such a crystal is generally called Ce:LYSO, where LYSO represents the chemical formula LU Lu₂₍₁₋ₓ₎Y₂ₓSiO₅ where x is a number comprised between 0 and 1. For the crystal used in the context of the invention, x is chosen to be equal to 0.2. In this case, the scintillator material 12 is capable of emitting 13,500 photons for a gamma radiation at 511 KeV for a LYSO scintillator material.

The emission spectrum of a scintillator material has a fairly large band inasmuch as the spectrum generally extends over several hundred nanometers (nm). Thus, photons generated by the scintillator material 12 have a wavelength comprised between 350 nm and 800 nm, preferably between 380 nm and 600 nm.

Furthermore, the emission of the generated photons is done at the first order without a favored direction with a solid angle of 4Π. In that sense, the scintillator material 12 behaves like a substantially isotopic light source.

As a result, the characterization device 10 can be used to characterize a substantially isotropic light source by replacing the scintillator material 12 with a substantially isotropic emission material. Preferably, this material is suitable for generating photons under the effect of an excitation. Thus, the characterization of the isotropic source makes it possible to determine the properties of the excitation.

The scintillator material 12 has a second refraction index n₂. The second refraction index n₂ is greater than the first refraction index n₁. As an example, the second refraction index n₂ is greater than 1.8.

The guide layer 16 is capable of guiding some of the photons generated by the scintillator material 12 toward a predetermined zone.

In the illustrated examples, the predetermined zone is the peripheral zone 22.

The guided photons are the photons that have an angle of incidence relative to the part of the wall 28 greater than or equal to the arcsin of the ratio of the first refraction index n₁ to the second refraction index n₂. The angle of incidence relative to an element means hereafter that the angle of incidence is defined relative to the local normal of the element.

According to the Snell-Descartes laws, the guided photons are therefore photons that are completely reflected at the interface between a medium having n₂ as refraction index and a medium having the first refraction index n₁ as its index.

In the example of FIG. 1, the guide layer 16 has a third refraction index n₃ that is advantageously greater than both the second refraction index n₂ and the first refraction index n₁. For example, the third refraction index n₃ is equal to 2.

The different refraction indices n₁, n₂ and n₃ are different two by two.

Additionally, according to one alternative, the guide layer 16 has an index gradient. In that case, the refraction index n₃ corresponds to the average index of the guide layer 16.

Furthermore, the guide layer 16 of FIG. 1 is in contact with the wall 28 of the rear face 32 of the scintillator material 12.

According to the embodiment of FIG. 2, the guide layer 16 is in contact with the front face 30 of the scintillator material 12.

Alternatively, the guide layer 16 completely surrounds the wall 28. The guide layer 16 is thus in contact with the front face 30, the rear face 32 and the side faces 34. This is in particular shown in the embodiments of FIGS. 3 and 4.

Thus, the guide layer 16, the ambient medium 26 and the scintillator material 12 form a waveguide.

Alternatively, the waveguide is formed by the scintillator material 12 on one side and a mixed layer on the other side. The mixed layer includes air in the peripheral zone 22 and an intermediate index material between the index of the air and the third index n₃ in the central zone 20.

This waveguide is greatly multimodal to increase photon collection. This means that the thickness of the guide layer 16 is large enough to allow the propagation of several modes. The thickness of at least one micrometer is advantageously desired for the guide layer 16.

Alternatively, an optical confinement layer is positioned around the guide layer 16. This optical confinement layer has a refraction index lower than the third refraction index n₃.

The optical refinement layer makes it possible to protect the guide layer 16 and favors handling and fastening of the assembly formed by the scintillator material 12 and the guide layer 16.

In each of the embodiments illustrated in FIGS. 1 to 4, the guide layer 16 includes at least one diffractive element 38. These diffractive elements 38 are optically coupled to the guide layer 16. The term “optically coupled” refers, in the context of this invention, to the fact that the diffracting elements 38 and the guide layer 16 are in optical communication. In other words, the diffracting elements 38 capture at least some of the photons guided in the guide layer 16.

According to the illustrated examples, the diffractive elements 38 are situated in the peripheral zone 22. This zone is advantageously chosen for its proximity to the scintillator material 12, where the photons are reflected and therefore lose the spatial information.

Each diffracting element 38 is suitable for directing photons in a direction forming an angle of incidence relative to the wall 28. This in particular makes it possible to orient photons toward the detector or a specific part thereof.

According to the illustrated examples, the diffracting elements 38 are capable of orienting the photons in the direction Z.

The diffracting elements 38 of FIGS. 1 to 4 are photonic crystals 40 etched in the guide layer 16.

According to one alternative that is not shown, the photonic crystal 40 is alongside the guide layer 16 and formed by a layer having an effective index smaller than the third index n₃ in which holes are formed in a material with a different index.

The geometry of the photonic crystals 40 is chosen so that the emitted light is diffracted perpendicular to the waveguides.

The geometry of a photonic crystal 40 is characterized by several parameters, as shown in FIGS. 5 and 6. A photonic crystal is a nanostructure in which a pattern is repeated. Here, the pattern comprises a blind hole with depth 42. The pattern is repeated over a limited extension 44. The patterns are repeated with a regular pitch 46. In the illustrated case, the size of the diameter 48 of the holes is also specified.

The photonic crystal 40 is in the material of the guide layer 16, while the holes are in the material of the ambient medium 26.

The depth 42 is comprised between several tens of nanometers and several micrometers, and is in particular equal to 500 nm.

The extension 44 is comprised between several hundreds of nanometers and several tens of micrometers, and is in particular equal to 2.3 μm. The pitch 46 is comprised between several hundreds of nanometers and several micrometers, and is in particular equal to 330 nm.

The diameter 48 is for example characterized by the filling rate, defined as the ratio of the total area occupied by the holes to the total area occupied by the guide layer 16. The filling rate is comprised between 0.1 and 0.9, and is in particular equal to 0.5.

The blind holes are for example positioned in staggered rows.

The specific choice of the different values for the depth 42, the extension 44, the pitch 46 and the diameter 48 is made using a method known by those skilled in the art by setting a filling rate and requiring operation in the first Brillouin zone for a zero wave vector (point often called Gamma point).

Thus, the emission direction of the photons by the photonic crystal 40 depends very little on the emission wavelength. This property makes the photonic crystals 40 well suited for orienting the photons in a given direction.

Furthermore, the emission of the photonic crystals 40 is substantially anisotropic, which still further increases that effect.

According to another embodiment, the geometry of the photonic crystal is a honeycomb, hexagonal, or may even be random.

Alternatively, the diffracting elements 38 are a surface having a roughness comprised between 10 nm and 2.0 micrometers (μm). The roughness is defined, in the context of this invention, as the variance of the roughness of the surface measured for example by atomic force microscopy (root mean squared (RMS) roughness).

The diffracting elements 38 have the advantage of being relatively compact. When bulk is not critical, other means make it possible to extract the photons toward the peripheral zone 22. As an example, a structure of the cube corner type or a guiding structure in the form of a funnel allows local extraction of the light.

In the embodiments of FIGS. 1 and 4, the photonic crystals 40 are arranged in the peripheral zone 22 to extract the photons guided by the guide layer 16 outside the guide layer 16.

Alternatively, the diffracting elements 38 are arranged to inject photons generated by the scintillator material 12 toward the guide layer 16. Diffracting elements 38 then serve as light couplers in the waveguide surrounding the scintillator material 12.

The diffracting elements 38 are then advantageously placed in the peripheral zone 22. Furthermore, the diffractive elements 38 are small according to this alternative. For a photonic crystal 40, this means that its length 44 is several tens of times larger than the pitch 46.

FIGS. 7 and 8 thus show, for two photonic crystal 40 geometries, the simulated coupling in the guide layer 16 of a planar light wave as a function of the wavelength in the vacuum of the light wave and the injection angle. The injection angle is defined by the angle of incidence of the planar wave relative to the normal of the guide layer 16.

A value of 1 (white) corresponds to 100% coupling of the light wave in the guide layer 16. A value of 0 (black) corresponds to 0% coupling of the light wave in the guide layer 16. The white line corresponds to the emission peak of the scintillator material 12, i.e., approximately 420 nm. The circles visually show the injection angles coupling in the guide layer 16.

The simulations were done using the “rigorous coupled wave analysis” (RCWA) calculation method.

In the case of FIG. 7, the pitch 46 of the photonic crystal is 380 nm with a filling rate of 0.5, a depth of 500 nm and an extension 44 equal to 3.8 μm. The photonic crystal of FIG. 8 has a pitch 46 of 700 nm with a filling rate of 0.5, a depth 42 of 500 nm and an extension 44 equal to 7 μm.

For FIG. 7, only the waves having a wavelength of 420 nm with a respective injection angle of 8.5° and 17.5° are effectively coupled in the guide layer 16.

In the case of FIG. 8, the waves having a wavelength of 420 nm with a respective injection angle of 56°, 43°, 32°, 25°, 13°, 4° effectively couple in the guide layer 16. This is particularly true for the waves with the angles of 56°, 43° 32°. The other angles of incidence are not coupled and are either transmitted to the outside or reflected toward the scintillator material 12.

Thus, these simulations show that a photonic crystal 40 is capable of increasing photon collection by the guide layer 16. Furthermore, the larger the pitch 46 of the photonic crystal 40, the more it is possible to couple the emitted light to several angles in the guide layer 16.

The detector 18 includes several photodetectors 50 and 52. A photodetector 50, 52 converts the energy of the photons into an electrical signal.

The photodetectors 50, 52 make it possible to detect a small number of photons. As a result, each photodetector 50, 52 has a good quantum efficiency. As an example, the quantum efficiency is greater than 25% at 420 nm, greater than 45% at 600 nm, and greater than 15% at 800 nm. For example, the quantum efficiency is equal to 30% at 420 nm, 60% at 600 nm, and 20% at 800 nm.

As a result, the detector 18 has a good sensitivity, or a good ratio of the number of detected light photons to the number of incident photons on the detector 18.

According to this embodiment, the photodetectors 50, 52 are for example a “Single Photon Avalanche Photodiode” (SPAD) matrix, i.e., avalanche photodiodes used in Geiger mode as single photon detector 18. The photodetectors 50, 52 thus form a silicon photomultiplier (SiPM).

Alternatively, the photodetectors 50, 52 are monocrystalline or amorphous silicon photodiodes or avalanche photodiodes (APD).

Some of the photodetectors 50 are situated in the central zone 20, while the other photodetectors 52 are situated in the peripheral zone 22.

According to one alternative, the photodetectors 50 have a quantum efficiency better than that of the photodetectors 52.

As an example, the proposed detector 18 is obtained by TSV (Through-Silicon Via) technology.

According to this technology, a glass wafer 54 (often called TSV glass), transparent in the visible domain, protects the photodetectors 50, 52. This wafer 54 is connected to the photodetectors 50, 52 by an adhesive 56. The adhesive is for example glue. The index of this adhesive is advantageously lower than the third index n₃.

The space 58 between the glue 56 and the photodetectors 50, 52 is filled with air or a so-called index adaptation material. An index adaptation material is a material having an index comprised between that of the glass and that of the photodetectors 50, 52.

The photodetectors 50 and 52 are protected on the front face by a first silicon oxide or silicon nitride layer 60, and on the rear face by a second silicon layer 62.

The retroreflector 14 makes it possible to reflect the photons generated by the scintillator material 12. This favors the collection output of the detector 18.

The retroreflector 14 being positioned across from the front face 30 of the scintillator material 12, it is the photons leaving the front face 30 that are reflected.

The retroreflector 14 is separated from the scintillator material 12 by the ambient medium 26. Alternatively, it is alongside the scintillator material 12.

The retroreflector 14 is made up of cube corners. Alternatively, the retroreflector 14 is a mirror or a layer that is painted white.

FIGS. 9 and 10 respectively show the mappings of the electrical vector in a direction parallel to the axis X and the magnetic field vector in a direction parallel to the axis Y. Thus, this figure characterizes the intensity of the electromagnetic radiation. These are simulation results. The simulation is a simulation of the electromagnetic fields generated by an ionizing radiation in a scintillator material 12. The simulation is obtained by using the finite difference time domain (FDTD) method. To reduce the calculation time, the dimensions of the scintillator material 12 have been reduced by a scaling factor.

In these FIGS. 9 and 10, three detectors have been positioned. The first detector D1 detects the photons emitted across from the event. The second detector D2 detects photons emitted by the interaction that are emitted by the photonic crystal 40, while the detector D3 detects the photons emitted by the interaction that leaves the scintillator material 12. The third detector D3 is placed across from a zone not containing photonic crystals. Furthermore, the third detector D3 is symmetrical with the second detector D2 relative to the first detector D1.

The improved extraction is obtained by a comparison between the signal received by the second detector D2 and that received by the third detector D3. This comparison is done using FIG. 11, which shows the power of the electromagnetic field detected by each detector D1, D2, D3 based on the simulation time (in arbitrary units). The curve 100 in solid lines shows the evolution measured for the first detector D1; the curve 102 in dotted lines shows that of the second detector D2; and the curve 104 in mixed lines shows that the third detector D3.

By comparing the two curves, in a stabilized system, a gain of 35.7% is observed.

The increased collection efficiency of the device 10 is in particular interesting for positron emission tomography applications.

During operation, the device 10 receives an ionizing radiation. Under the effect of the ionizing radiation, the scintillator material 12 emits photons.

The photons emitted by the scintillator material 12 during the interaction with the ionizing radiation follow different paths based on their incidence relative to the wall 28.

A photon emitted by the scintillator material 12 emitted in a direction substantially perpendicular to the rear face 32 passes through the latter without significant deviation. It is detected by a photodetector 50 situated in the central zone 20. This photon is therefore a photon directly joining the photodetector 50 without undergoing total reflection. As a result, this photon is a photon making it possible to locate the interaction between the ionizing radiation and the scintillator material 12.

A photon generated by the scintillator material 12 in a direction forming an angle of incidence larger than the arcsin of the ratio of the first refraction index n₁ to the second refraction index n₂ is collected by the guide layer 16 toward the peripheral zone 22. This is in particular the case for the photons emitted toward the side faces 34. A diffracting element 38 allows the extraction of the guided photon toward the photodetector 52 situated in the peripheral zone 22. This photon has undergone multiple total reflections. It has therefore lost the information relative to the location of the interaction between the ionizing radiation and the scintillator material 12. The photon is, however, usable to improve the energy resolution of the detector 18.

Thus, the device 10 makes it possible to separate the photons keeping the information on the interaction point of the absorption of an ionizing radiation from the photons that have lost that information. Furthermore, the device 10 makes it possible to detect those photons over dedicated zones of the detector 18.

As a result, the device 10 is well suited to characterizing the incident ionizing radiation.

In the example of the invention, this characterization includes determining the intensity of the ionizing radiation and that of the point of interaction between the ionizing radiation and the scintillator material 12.

The device 10 therefore makes it possible to improve the extraction of the photons having lost the information on the point of interaction over the dedicated detection zones.

The device 10 also makes it possible to improve the energy resolution, which makes it possible to improve the discrimination between events.

Furthermore, the detection sensitivity to the ionizing radiations is improved, since the signal-to-noise ratio of the detected photons is increased.

Furthermore, the device 10 is easy and inexpensive to manufacture. This is in particular due to the fact that the device 10 comprises a bulk scintillator material 12. A bulk scintillator material 12 is easier to manufacture than a “pixelated” scintillator material. Such a pixelated material is in particular used in the aforementioned document WO-A-2010/109344.

To illustrate this easy manufacturing, a method for manufacturing the device 10 is also proposed.

The method for manufacturing the device 10 comprises a step for preparing the scintillator material 12. This preparation step comprises the optional production of bevels 36 at the edges of the scintillator material 12.

The method also comprises a step for depositing the guide layer 16 around the wall 28 of the scintillator material 12. According to one embodiment, the deposition done is a chemical vapor deposition. For example, an LPCVD (low-pressure chemical vapor deposition) of silicon nitride (NSi formula) is used.

Alternatively, other deposition techniques are used, such as large surface sol-gel deposition techniques. This is particularly suitable for hafnium oxide (chemical formula HFO₂).

Thus, the deposition step is an easy step to carry out, since the proposed techniques are techniques mastered by those skilled in the art. Furthermore, because the guide layer 16 allows the guiding of several modes, the machining allowance on the thickness is very significant: more than 10%.

The method also comprises a lithography step for the diffracting elements 38.

For the photonic crystals 40, for example, a nanoprinting technique is particularly suited to the production of photonic crystals 40 to improve the extraction of the light from polymer films.

FIGS. 12 to 14 illustrate an example of the manufacturing of photonic crystals 40 by nanoprinting.

The method includes a step for preparing a silicon mold 106.

The preparation of the mold 106 comprises treating the mold 106 with an anti-adhesive layer. As an illustration, the anti-adhesive layer is a monolayer of molecules containing fluorinated atoms.

The preparation of the mold 106 comprises producing structures 108. The structures 108 form a negative of the photonic crystal 40. In that case, the structures 108 are therefore projections relative to the mold 106. This mold 106 is shown in FIG. 12.

The method also includes a step for depositing a thermoplastic polymer film 110 on the surface of the guide layer 16 meant to comprise the photonic crystals 40. As an example, the thermoplastic film 110 is polymethyl methacrylate (often abbreviated PMMA). Alternatively, the film 110 deposited in this step is a thermosetting or ultraviolet-setting film.

In FIG. 12, the assembly of the scintillator material 12 provided with the guide layer 16 and a thermoplastic film 110 obtained at the end of the deposition step is shown.

The method includes a step for heating the mold 106 and the assembly at a temperature above the glass transition temperature of the thermoplastic polymer. The glass transition temperature is generally denoted T_{g} in reference to its name. The temperature reached during this heating step is typically 20° C. to 50° C. above the glass transition temperature T_{g}.

At this temperature, the mold 106 is pressed against the polymer film 110, as indicated by the arrow 112 in FIG. 12. The pressure exerted on the mold 106 varies between several bars and 40 bars.

Then, the method includes a step for cooling the mold 106 and the assembly to a temperature below the glass transition temperature T_{g}.

The method comprises a step for separating the mold from the assembly, as indicated by the arrow 114 FIG. 13.

An assembly of the scintillator material 12 provided with the guide layer 16 and the thermoplastic film 110 obtained at the end of the separating step is shown in FIG. 13. The film 110 then includes structures 116 in the form of holes corresponding to the structures 108 of the mold 106. Thus, the film 110 forms an etching mask making it possible to obtain photonic crystals 40 on the guide layer 16.

The method then includes a dry etching step to transfer the structures 116 produced on the thermoplastic film 110 onto the guide layer 16.

By eliminating the film 110, a scintillator material assembly 12 surrounded by the guide layer 16 with its photonic crystals 40 is obtained. This is shown in FIG. 14.

As an alternative to the nanoprinting technique, to produce the diffracting elements 38, other standard lithography techniques, such as photolithography or electron bombardment etching or ultraviolet etching, are used. Depending on the case, these techniques may or may not be associated with dry etching techniques.

The method lastly includes a step for assembling the assembly to the detector 18.

1. A device for characterizing an ionizing radiation used in an ambient medium having a first refraction index, the device comprising:
a scintillator material delimited by a wall, the scintillator material generating photons under the effect of an ionizing radiation, the scintillator material having a second refraction index, and
a guide layer in contact with at least part of the wall, the guide layer guiding toward a predetermined zone, the photons generated by the scintillator material and having an angle of incidence relative to the part of the wall greater than or equal to the arcsin of the ratio of the first refraction index to the second refraction index, the material of the guide layer having a third refraction index, the third refraction index being greater than the first and second refraction indices, the guide layer including at least one diffracting element suitable for orienting photons in a predetermined direction.

2. The device according to claim 1, wherein at least one of the diffracting element(s) is arranged to inject photons generated by the scintillator material toward the guide layer.

3. The device according to claim 1, wherein at least one of the diffracting element(s) is arranged to extract the photons guided by the guide layer outside the guide layer.

4. The device according to claim 2, wherein at least one of the diffracting element(s) is arranged to extract the photons guided by the guide layer outside the guide layer.

5. The device according to claim 1, wherein the device comprises a central zone and a peripheral zone, the predetermined zone being the peripheral zone and the diffractive elements being situated in the peripheral zone.

6. The device according to claim 2, wherein the device comprises a central zone and a peripheral zone, the predetermined zone being the peripheral zone and the diffractive elements being situated in the peripheral zone.

7. The device according to claim 3, wherein the device comprises a central zone and a peripheral zone, the predetermined zone being the peripheral zone and the diffractive elements being situated in the peripheral zone.

8. The device according to claim 4, wherein the device comprises a central zone and a peripheral zone, the predetermined zone being the peripheral zone and the diffractive elements being situated in the peripheral zone.

9. The device according to claim 5, wherein the device comprises a detector including several photodetectors, some of the photodetectors being situated in the central zone and other photodetectors being situated in the peripheral zone.

10. The device according to claim 6, wherein the device comprises a detector including several photodetectors, some of the photodetectors being situated in the central zone and other photodetectors being situated in the peripheral zone.

11. The device according to claim 7, wherein the device comprises a detector including several photodetectors, some of the photodetectors being situated in the central zone and other photodetectors being situated in the peripheral zone.

12. The device according to claim 8, wherein the device comprises a detector including several photodetectors, some of the photodetectors being situated in the central zone and other photodetectors being situated in the peripheral zone.

13. The device according to claim 1, wherein the diffracting elements are chosen from a group made up of a photonic crystal and a surface having a roughness comprised between 10 nm and 2.0 μm.

14. The device according to claim 1, wherein the guide layer completely surrounds the wall.

15. The device according to claim 1, wherein the scintillator material is a rectangular rhomb whereof the edges have a bevel.

16. A method for manufacturing a device according to claim 1, comprising the following steps:
chemical vapor deposition of the guide layer on the wall of the scintillator material, and
lithography of the diffracting elements, in particular by nanoprinting on a film deposited on the guide layer.

17. A use of a device according to claim 1 for characterizing an ionizing radiation.

18. The use according to claim 17, wherein the characterization includes determining the energy of the ionizing radiation.

19. The use according to claim 17, wherein the characterization includes determining the point of interaction between the ionizing radiation and the scintillator material.

20. The use according to claim 18, wherein the characterization includes determining the point of interaction between the ionizing radiation and the scintillator material.
